(19) United States
(12) Patent Application Publication
(10) Pub. No.: US 2022/0193828 A1
(43) Pub. Date: Jun. 23, 2022

(54) LIFT-OFF STRUCTURE FOR SPRAYED THIN LAYER ON SUBSTRATE SURFACE AND METHOD FOR THE SAME

(71) Applicant: AMULAIRE THERMAL TECHNOLOGY, INC., New Taipei City (TW)

(72) Inventors: Cheng-Shu Peng, New Taipei City (TW); Tze-Yang Yeh, New Taipei City (TW); Chih-Hung Shih, Hsinchu County (TW)

(21) Appl. No.: 17/132,162

(22) Filed: Dec. 23, 2020

(51) Int. Cl. B23K 26/40; B05D 1/12; B05D 3/06; C09D 5/00; C09D 7/61

(52) U.S. Cl. CPC B23K 26/40; B05D 1/12; B05D 3/065; B05D 2203/30; C09D 7/61; B05D 2201/02; C09D 5/008

(57) ABSTRACT

A lift-off structure for a sprayed thin layer on a substrate surface and a method for the same are provided. The lift-off structure for the sprayed thin layer on the substrate surface includes a base layer and a lifted-off sprayed thin layer. The lifted-off sprayed thin layer is formed on the base layer. The lifted-off sprayed thin layer has at least one ablated new side surface formed thereon, and the at least one ablated new side surface has an inclination angle.

### FIELD OF THE DISCLOSURE

The present disclosure relates to a lift-off structure and a method for the same, and more particularly to a lift-off structure for a sprayed thin layer on a substrate surface and a method for the same.

### BACKGROUND OF THE DISCLOSURE

When a material required by a substrate of a product is different from a material required by a functional region, a sprayed layer is conventionally formed on the substrate by way of spraying and masking, so as to achieve heterogeneous integration. However, when a demand for higher dimensional precision of the sprayed layer or a need for fine patterning arises, the conventional method of forming the sprayed layer by way of masking and spraying does not meet relevant requirements.

### SUMMARY OF THE DISCLOSURE

In response to the above-referenced technical inadequacies, the present disclosure provides a lift-off structure for a sprayed thin layer on a substrate surface and a method for the same.

In one aspect, the present disclosure provides a lift-off structure for a sprayed thin layer on a substrate surface. The lift-off structure includes a base layer and a lifted-off sprayed thin layer formed on the base layer. The lifted-off sprayed thin layer has at least one ablated new side surface formed thereon, and the at least one ablated new side surface has an inclination angle.

In an exemplary embodiment, a thickness of the lifted-off sprayed thin layer ranges from 50 μm to 1 mm.

In an exemplary embodiment, the inclination angle of the at least one ablated new side surface ranges from 0 to 10 degrees.

In an exemplary embodiment, the base layer is a polymer composite layer constituted by a polymer composite material.

In an exemplary embodiment, the base layer includes a filler, and the filler is selected from at least one of aluminum oxide, aluminum nitride, silicon nitride, silicon carbide, and boron nitride.

In an exemplary embodiment, the base layer is a ceramic material layer constituted by a ceramic material.

In another aspect, the present disclosure provides a method for lifting off a sprayed thin layer on a substrate surface, which includes: (a) forming a sprayed thin layer on a base layer by spraying; (b) irradiating the sprayed thin layer by one or a plurality of pulsed laser sources; and (c) lifting off the sprayed thin layer by ablation, so that the sprayer thin layer has at least one ablated new side surface formed thereon, and the at least one ablated new side surface has an inclination angle.

In an exemplary embodiment, the pulsed laser source having a light wavelength of 300 nm to 500 nm irradiates a central location of the sprayed thin layer, so that a material at the central location of the sprayed thin layer is lifted off to form the at least one ablated new side surface.

In an exemplary embodiment, the plurality of pulsed laser sources having a light wavelength of 300 nm to 500 nm irradiate an edge of the sprayed thin layer, so that a material at the edge of the sprayed thin layer is lifted off to form the at least one ablated new side surface.

In an exemplary embodiment, the inclination angle of the at least one ablated new side surface ranges from 0 to 10 degrees.

One of the beneficial effects of the present disclosure is that, in the lift-off structure for the sprayed thin layer on the substrate surface and the method for the same as provided in the present disclosure, one lifted-off sprayed thin layer is formed through lifting off the sprayed thin layer by a nanosecond pulsed laser. The lifted-off sprayed thin layer has at least one ablated new side surface formed thereon, and an inclination of the ablated new side surface is extremely small. Therefore, compared with a sprayed thin layer formed by a conventional masking and spraying method, the sprayed thin layer of the present disclosure is capable of satisfying a requirement for high precision.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a perspective schematic view of a lift-off structure for a sprayed thin layer on a substrate surface according to an embodiment of the present disclosure.

FIG. 2A is a side view of the lift-off structure for the sprayed thin layer on the substrate surface according to the embodiment of the present disclosure.

FIG. 2B shows an enlarged view of part IIB of FIG. 2A.

FIG. 3 is a perspective schematic view of a lift-off structure for a sprayed thin layer on a substrate surface according to another embodiment of the present disclosure.

FIG. 4 to FIG. 6B are schematic views showing a processing process of a method for lifting off the sprayed thin layer on the substrate surface according to the embodiment of the present disclosure.

FIG. 7 to FIG. 9B are schematic views showing a processing process of a method for lifting off the sprayed thin layer on the substrate surface according to another embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

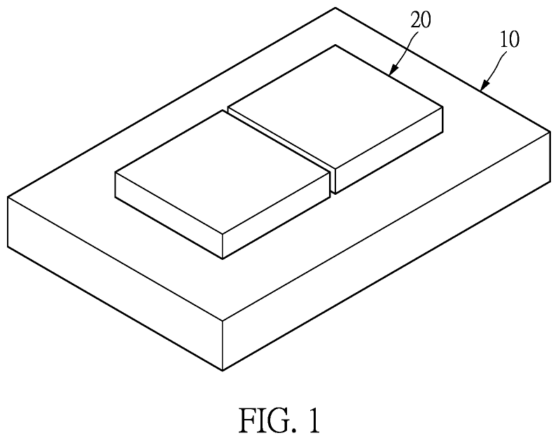

Referring to FIG. 1, a lift-off structure for a sprayed thin layer on a substrate surface is provided in an embodiment of the present disclosure. As shown in FIG. 1, the lift-off structure for the sprayed thin layer on the substrate surface provided in the embodiment of the present disclosure includes a base layer 10 and a lifted-off sprayed thin layer 20.

In one embodiment, the base layer 10 is a polymer composite layer constituted by a polymer composite material. Specifically, the base layer 10 can be an epoxy-based layer. The base layer 10 can also be a polyimide-based layer or a polypropylene-based layer. Further, the base layer 10 can include a filler, which is selected from at least one of aluminum oxide, aluminum nitride, silicon nitride, silicon carbide, and boron nitride.

In one embodiment, the base layer 10 is a ceramic material layer constituted by a ceramic material. Specifically, the ceramic material of the base layer 10 can be selected from aluminum oxide, but can also be selected from aluminum nitride, silicon nitride, or silicon carbide.

In one embodiment, the base layer 10 is partly constituted by the polymer composite material, while the rest of the base layer 10 is constituted by the ceramic material.

The lifted-off sprayed thin layer 20 is formed on the base layer 10. The lifted-off sprayed thin layer 20 can be constituted by a metallic material, such as copper. Specifically, the lifted-off sprayed thin layer 20 can be one sprayed thin layer having a predetermined thickness and being formed through the granular metallic material hitting a surface of the base layer 10 at a high speed by use of supersonic airflow. In the present embodiment, a thickness of the lifted-off sprayed thin layer 20 ranges from 50 μm to 1 mm.

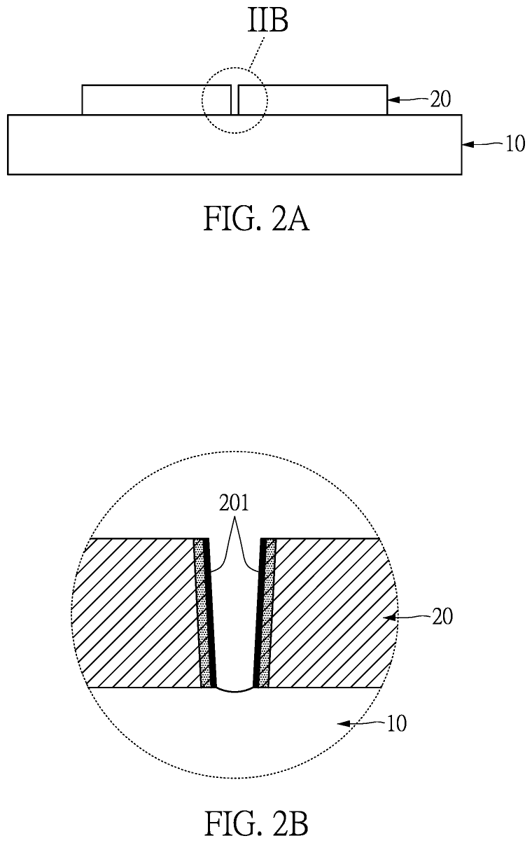

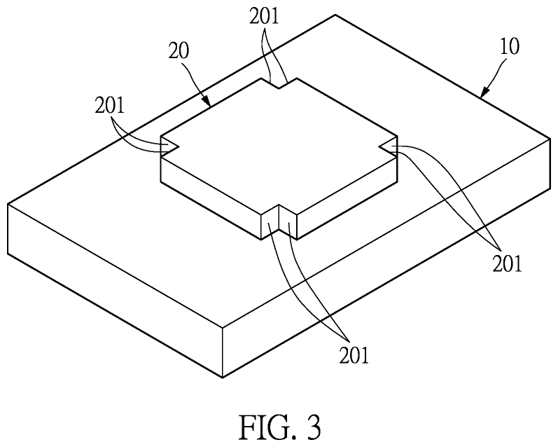

The lifted-off sprayed thin layer 20 has at least one ablated new side surface 201 formed thereon. Specifically, by having a specific location or an edge of a thin layer irradiated by one or a plurality of nanosecond pulsed laser sources, a material at the specific location or the edge is ablated and lifted off, and a new side surface showing traces of ablation (i.e., the ablated new side surface 201) is formed. In the present embodiment, as shown in FIG. 2A and 2B, there are two ablated new side surfaces 201 formed at a central location of the lifted-off sprayed thin layer 20. In another embodiment, as shown in FIG. 3, there are eight ablated new side surfaces 201 formed at edges of the lifted-off sprayed thin layer 20.

The ablated new side surface 201 has an inclination angle. Specifically, the inclination angle of the ablated new side surface 201 ranges from 0 to 10 degrees. That is to say, the inclination angle of the ablated new side surface 201 with respect to a normal direction of the base layer 10 ranges from 0 to 10 degrees.

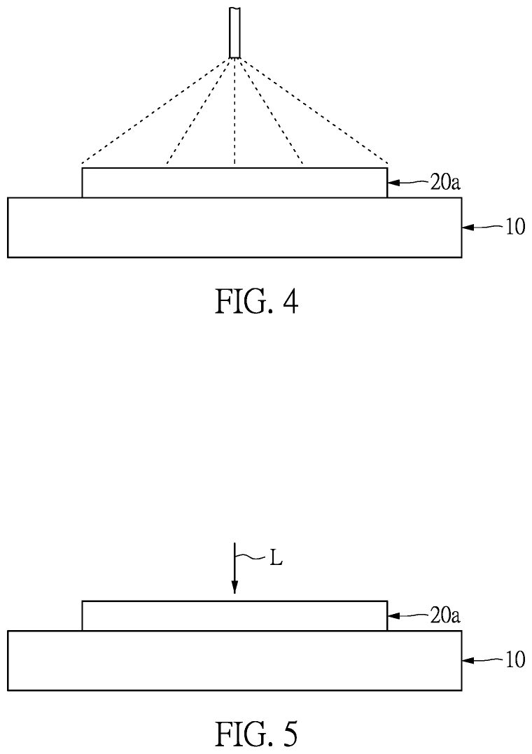

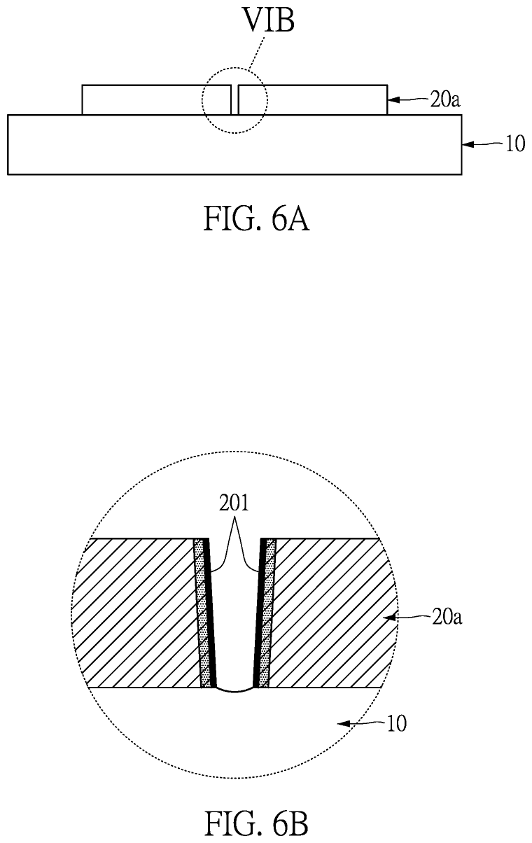

Referring to FIG. 4 to FIG. 6B, a method for lifting off a sprayed thin layer on a substrate surface is provided in the embodiment of the present disclosure. The method mainly includes the following steps.

(a) Forming a sprayed thin layer 20a on a base layer 10 by spraying.

(b) Irradiating the sprayed thin layer 20a by one or a plurality of pulsed laser sources L. In the present embodiment, a central location of the sprayed thin layer 20a is irradiated by one pulsed laser source L. Further, the pulsed laser source L is a pulsed laser source having a light wavelength of 300 nm to 500 nm, so as to achieve a nanoscale processing precision.

(c) Lifting off the central location of the sprayed thin layer 20a by ablation, so that a material at the central location of the sprayed thin layer 20a is lifted off to form at least one ablated new side surface 201. In the present embodiment, two ablated new side surfaces 201 facing each other are formed after the material at the central location of the sprayed thin layer 20a is ablated. The ablated new side surfaces 201 each have an inclination angle, which ranges from 0 to 10 degrees.

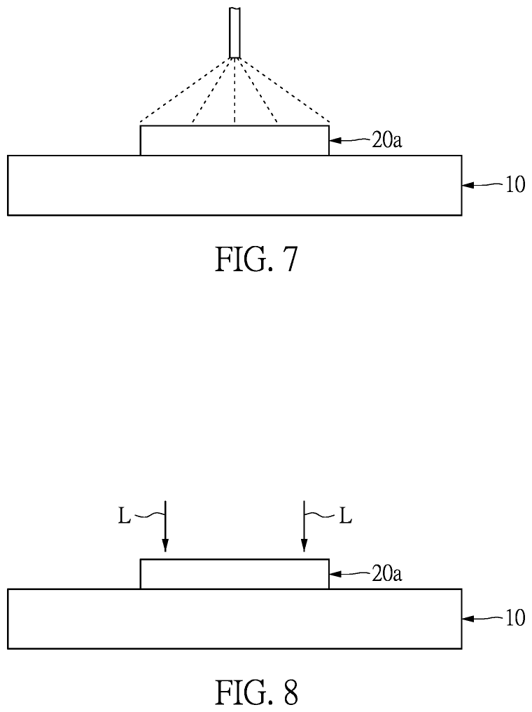

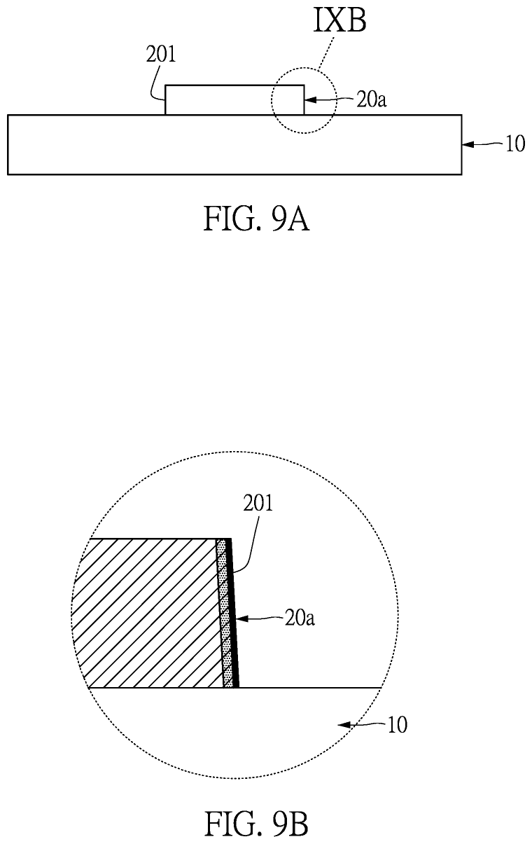

Referring to FIG. 7 to FIG. 9B, a method for lifting off a sprayed thin layer on a substrate surface is provided in another embodiment of the present disclosure. The method mainly includes the following steps.

(a) Forming a sprayed thin layer 20a on a base layer 10 by spraying.

(b) Irradiating the sprayed thin layer 20a by one or a plurality of pulsed laser sources L. In the present embodiment, an edge of the sprayed thin layer 20a is irradiated by the plurality of pulsed laser sources L having a light wavelength of 300 nm to 500 nm.

(c) Lifting off the edge of the sprayed thin layer 20a by ablation, so that a material at the edge of the sprayed thin layer 20a is lifted off to form at least one ablated new side surface 201. In the present embodiment, two ablated new side surfaces 201 opposite to each other are formed after the edge of the sprayed thin layer 20a is ablated. The ablated new side surfaces 201 each have an inclination angle, which ranges from 0 to 10 degrees.

In conclusion, in the lift-off structure for the sprayed thin layer on the substrate surface and the method for the same as provided in the present disclosure, one lifted-off sprayed thin layer is formed through lifting off the sprayed thin layer by a nanosecond pulsed laser. The lifted-off sprayed thin layer has at least one ablated new side surface formed thereon, and an inclination of the ablated new side surface is extremely small. Therefore, compared with a sprayed thin layer formed by a conventional masking and spraying method, the sprayed thin layer of the present disclosure is capable of satisfying a requirement for high precision.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A lift-off structure for a sprayed thin layer on a substrate surface, comprising:
a base layer; and
a lifted-off sprayed thin layer formed on the base layer, wherein the lifted-off sprayed thin layer has at least one ablated new side surface formed thereon, and the at least one ablated new side surface has an inclination angle.

2. The lift-off structure according to claim 1, wherein a thickness of the lifted-off sprayed thin layer ranges from 50 μm to 1 mm.

3. The lift-off structure according to claim 2, wherein the inclination angle of the at least one ablated new side surface ranges from 0 to 10 degrees.

4. The lift-off structure according to claim 1, wherein the base layer is a polymer composite layer constituted by a polymer composite material.

5. The lift-off structure according to claim 4, wherein the base layer includes a filler, and the filler is selected from at least one of aluminum oxide, aluminum nitride, silicon nitride, silicon carbide, and boron nitride.

6. The lift-off structure according to claim 1, wherein the base layer is a ceramic material layer constituted by a ceramic material.

7. A method for lifting off a sprayed thin layer on a substrate surface, the method comprising:
(a) forming a sprayed thin layer on a base layer by spraying;
(b) irradiating the sprayed thin layer by one or a plurality of pulsed laser sources; and
(c) lifting off the sprayed thin layer by ablation, so that the sprayer thin layer has at least one ablated new side surface formed thereon, and the at least one ablated new side surface has an inclination angle.

8. The method according to claim 7, wherein the pulsed laser source having a light wavelength of 300 nm to 500 nm is used in the step (b) to irradiate a central location of the sprayed thin layer, so that a material at the central location of the sprayed thin layer is lifted off to form the at least one ablated new side surface.

9. The method according to claim 7, wherein the plurality of pulsed laser sources having a light wavelength of 300 nm to 500 nm are used in the step (b) to irradiate an edge of the sprayed thin layer, so that a material at the edge of the sprayed thin layer is lifted off to form the at least one ablated new side surface.

10. The method according to claim 7, wherein the inclination angle of the at least one ablated new side surface ranges from 0 to 10 degrees.
